(19) United States
(12) Patent Application Publication
(10) Pub. No.: US 2014/0123036 A1
(43) Pub. Date: May 1, 2014

(54) TOUCH SCREEN DISPLAY PROCESS

(71) Applicant: International Business Machines Corporation, Armonk, NY (US)

(72) Inventors: Sheng Hua Bao, Beijing (CN); Keke Cai, Beijing (CN); Wei Hong Qian, Beijing (CN); Zhong Su, Beijing (CN); Li Zhang, Beijing (CN); Shiwan Zhao, Beijing (CN)

(73) Assignee: International Business Machines Corporation, Armonk, NY (US)

(21) Appl. No.: 14/050,588

(22) Filed: Oct. 10, 2013

(30) Foreign Application Priority Data
Oct. 31, 2012 (CN) 201210428036.0

(51) Int. Cl. G06F 3/048

(52) U.S. Cl. CPC G06F 3/048
USPC 715/760

(57) ABSTRACT

A method, apparatus for touch screen display process, and a browser are provided in the present disclosure. The method comprises: identifying Web elements used for Web interaction displayed on a touch screen; in response to a first action of a user on the touch screen, displaying the Web element pointed by the first action with enlargement; and in response to a second action of the user on the touch screen, triggering a Web interaction operation corresponding to the Web element pointed by the first action. According to the above technical solution, by displaying the Web element pointed by the first action of the user with enlargement, the user can preview the Web element that he actually selects, and a Web interaction is triggered only if it is determined that the Web element desired by the user has been correctly selected. Therefore, precise click can be realized.

### PRIORITY

This application claims priority to Chinese Patent Application No. 201210428036.0, filed Oct. 31, 2012, and all the benefits accruing therefrom under 35 U.S.C. §119, the contents of which in its entirety are herein incorporated by reference.

### BACKGROUND

The present invention relates to the field of user terminals, and more specifically, to a method and apparatus for touch screen display process, and a browser in the field of user terminals.

Touch screens have been widely employed in more and more user terminals (also called as IT terminals). Through providing touch screens, user terminals, such as mobile phones, satellite navigating equipments, video game machines, tablet computers, personal digital assistants (PDA), etc., cannot only display visible contents to users, but also use the touch screens as input devices to receive inputs resulted from touch actions of users and so on. A user terminal provided with a touch screen can detect the occurrence and position of a touch within its display area, and by enabling a user to directly perform input and/or control operation through the touch screen, the user terminal provides more intuitive and convenient performances as compared to operation with a cursor by means of a mouse to control visual contents indirectly.

Many techniques have been developed to support the use of touch screens, for example, the resistive touch screen, the surface acoustic wave touch screen, the capacitive touch screen, etc. No matter which technique is employed, it is necessary to optimize the touch screen to sense actions on the touch screen by user fingers or other portions as precisely as possible. Take a touch screen which receives an input through a touch action as an example. In fact, users are usually unable to precisely touch positions where they want to touch, and this result from the following reasons: touch offsets due to small-sized contents displayed on the touch screen and large-sized contact areas on the touch screen of a user finger; touch offsets caused by human visual discrepancy or large granularity of human body displacement and the like. For example, when a user browses a webpage on a mobile phone, because the link font is generally smaller than the size of a user finger, it is very easy for the user to click a link close to what he wants to click originally, which is undesirable for the user.

Currently, in order to enable users to recognize small-sized contents displayed in a restricted display area as clearly as possible, several text preview techniques have been proposed. For example, when a virtual keyboard displayed on a touch screen is touched by a user, the content of a virtual key clicked by the user is enlarged for previewing by the user, so that the user can determine whether a correct key is clicked. As another example, currently displayed contents can be entirely magnified through the multi-touch technique, and however, some contents may go beyond the display area due to the overall magnification, leading to an incomplete display. As still another example, a “magnifier” component can be virtually displayed on a touch screen, and a user can move the “magnifier” component to magnify texts covered by the “magnifier” component.

However, the above preview techniques may only allow users to clearly recognize the displayed texts passively, but cannot facilitate users to precisely click the desired links, buttons and other interactive contents in the currently-displayed webpage with small-sized texts and pictures. Thus, with the above preview techniques, although users are enabled to clearly identify contents displayed in a restricted display area, precise click operation by the users cannot be realized.

In order to make a user able to perform precise click operation on a webpage displayed in a restricted display area, one known method is to convert a conventional webpage displayed on a computer to a mobile webpage which is suitable for displaying on a mobile device, and simulate a click operation for a link on the converted mobile webpage based on preset sliding gestures. When a user performs a predefined action on the converted mobile webpage, a link pointed by the action is therefore clicked, triggering an interactive operation corresponding to this link.

However, such webpage conversion makes it difficult for a user to find desired contents in an unfamiliar webpage layout. As a result, user experience is degraded. Further, cost required for maintaining both a conventional webpage and its converted mobile webpage is increased. Moreover, Clicking on a link requires preset sliding gestures, and unfortunately, sliding gestures also have errors and cannot be controlled precisely. Therefore, several links close to each other may correspond to an identical sliding gesture, and thus an undesired link among them may be wrongly selected in response to such a gesture. That is, when a user performs a sliding gesture, the link pointed by the gesture is not the link desired to be pointed by the gesture. Therefore, the method of clicking on a link through a sliding gesture cannot address the above problem of precise click in nature.

### SUMMARY

According to one embodiment of the present invention, there is provided a method for touch screen display process, comprising: identifying Web elements used for Web interaction displayed on a touch screen; in response to a first action of a user on the touch screen, displaying the Web element pointed by the first action with enlargement; and in response to a second action of the user on the touch screen, triggering a Web interaction operation corresponding to the Web element pointed by the first action.

According to another embodiment of the present invention, there is provided an apparatus for touch screen display process, comprising: an identification component, configured to identify Web elements used for Web interaction displayed on a touch screen; an enlargement display component, configured to in response to a first action of a user on the touch screen, display the Web element pointed by the first action with enlargement; and a triggering component, configured to in response to a second action of the user on the touch screen, trigger a Web interaction operation corresponding to the Web element pointed by the first action.

According to still another embodiment of the present invention, there is provided a browser comprising the above apparatus.

### BRIEF DESCRIPTION OF THE SEVERAL VIEWS OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 shows an exemplary computer system which is applicable to implement the embodiments of the present invention;

FIG. 2 is a flowchart of a method for touch screen display process according to an embodiment of the present invention;

FIG. 3 is a flowchart of another method for touch screen display process according to an embodiment of the present invention;

FIGS. 4A, 4B, 4C, 4D, 4E and 4F are examples of contents displayed on a touch screen when performing the method according to the embodiments of the present invention on the touch screen;

FIG. 5 is a structural block diagram of an apparatus for touch screen display process according to an embodiment of the present invention;

FIG. 6 is a structural block diagram of another apparatus for touch screen display process according to an embodiment of the present invention;

FIG. 7 is a structural block diagram of a browser according to an embodiment of the present invention.

### DETAILED DESCRIPTION

Embodiments of the present invention are intended to provide a method and apparatus for touch screen display process and a browser, for addressing the problem of precise click by a user on a touch screen, such that even for small-sized contents displayed on the touch screen, the user can perform precise click operations on the touch screen conveniently to trigger correct interactive operations.

According to the technical solutions provided in embodiments of the present invention, by displaying the Web element pointed by the first action of the user with enlargement, the user can preview the Web element that he actually selects, and a Web interaction is triggered by a second action only if it is determined that the Web element desired by the user has been correctly selected. Therefore, a precise click can be realized.

Some exemplary embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operations to be performed on the computer, other programmable apparatus or other devices to produce a computer implemented process such that the instructions which execute on the computer or other programmable apparatus provide processes for implementing the functions/acts specified in the flowchart and/or block diagram block or blocks.

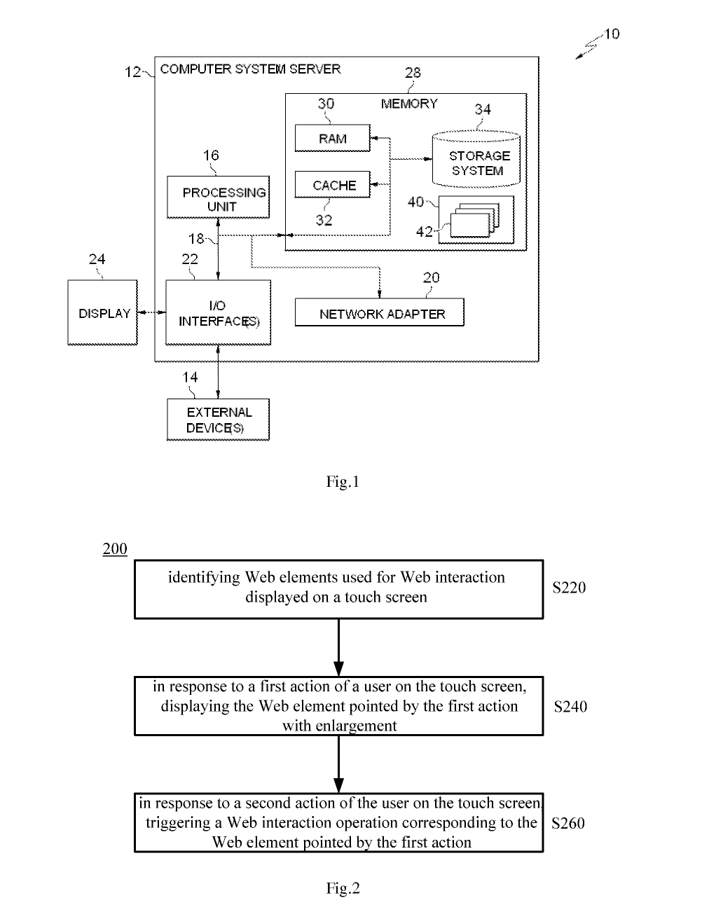

Referring now to FIG. 1, in which an exemplary computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

With reference now to FIG. 2, a method 200 for touch screen display process according to an embodiment of the present invention will be described in detail.

In the method 200 shown in FIG. 2, Web elements used for Web interaction displayed on a touch screen are identified at block 5220; at block 5240, in response to a first action of a user on the touch screen, a Web element pointed by the first action is displayed with enlargement; and at block 5260, in response to a second action of the user on the touch screen, a Web interaction operation corresponding to the Web element pointed by the first action is triggered.

Specifically, for example, when a user wants to click a certain Web element on a webpage displayed on the touch screen, the user performs a first action on the touch screen. A user terminal provided with the touch screen performs enlargement display on a Web element which the user terminal determines to be pointed by the first action. Through enlargement display of the Web element, the user can preview the Web element his action actually points to, and thus determine whether the Web element, which is actually determined by the user terminal according to his first action, is the Web element he wants to select by the first action. After the user has previewed the Web element displayed with enlargement, if the Web element is the one desired by the user, the user performs a second action on the touch screen, which may cause the user terminal to trigger a Web interaction operation corresponding to the Web element displayed with enlargement, so that the corresponding Web interaction is performed.

The term “Web element” as mentioned herein may be various links used for Web interaction displayed on the touch screen. These links can be represented in the form of texts, pictures, or buttons, etc. When a Web element is clicked by a user, the associated Web interaction can be performed, for example, rendering a new webpage the link points to, displaying associated video/audio contents, popping out a dialog box, recording information input to the webpage by the user, and various other operations allowing user to interact with a network.

The term “touch screen” as mentioned herein can not only include existing capacitive touch screens, resistive touch screens, surface acoustic wave touch screens and so on, but also include other screens capable of both displaying information to users and receiving user inputs as input devices. In order to input on a touch screen, a user is required to contact the screen with his finger directly, or contact the screen with other articles such as a touch pen.

Since touch screens may be implemented with different techniques, the manner in which a user performs an input operation on a touch screen may be different. According to an embodiment of the present invention, actions performed by a user on the touch screen may need the user to contact with the touch screen, or not need such a contact. As such, for example, the first action may be a touch action, i.e., contacting the touch screen with for example a finger of the user; the second action may be a touch-stop action, i.e., removing for example the finger of the user away from the touch screen. As another example, the first action may be an action satisfying a first predetermined condition, and the second action may be an action satisfying a second predetermined condition.

According to an embodiment of the present invention, the first predetermined condition may be related to at least one of a time domain behavior and a spatial domain behavior of the first action, and the second predetermined condition may be related to at least one of a time domain behavior and a spatial domain behavior of the second action. The time domain behavior of an action may comprise how long the action exists in time domain. The spatial domain behavior of an action may comprise what spatial shape the locus of the action looks like. For example, when a user's finger touches a touch screen for two seconds and draws a circle on the screen, the duration of two seconds belong to the time domain behavior, and drawing a circle belongs to the spatial domain behavior. If the first predetermined condition is that the duration of a touch is larger than one second and the locus of the touch moving on the touch screen looks like an approximate circle, such an action is considered as belonging to the first action. As another example, when a user's finger contacts on a touch screen while drawing an “8” shape on the screen, drawing the “8” shape is a spatial domain behavior, and in this case, no time domain behavior may be defined. If the second predetermined condition is that a locus of a touch moving on a touch screen looks like an approximate “8” shape, such an action can be considered as belonging to the second action. It may easily occur to those skilled in the art that the first action and the second action can be defined in different manners, for example, by different finger movement patterns, different finger click times, different press duration on a touch screen, different speeds at which a predetermined pattern is formed, etc. By identifying the first and second actions according to preset conditions, the user terminal can perform enlargement display process and trigger Web interaction operation.

The Web element pointed by the first action may not be necessarily the Web element that the user wants to select through the first action, but the Web element identified by the user terminal provided with a touch screen according to the first action. Since there is a difference between the area of a user's finger and the size of content displayed on a touch screen, the Web element identified by the user terminal may not be necessarily the one the user wants to click. For example, the user terminal can determine the Web element pointed by the first action according the occurrence position of the first action on the touch screen and the position of the Web element displayed in the screen.

For example, if the touch position of the user on the touch screen covers three Web elements, the user terminal may consider that the Web element closest to the center of the user's touch position is the Web element pointed by the touch action, and then determine to display this Web element with enlargement. In another embodiment, the user terminal may display the three Web elements with enlargement together, with the Web element pointed by the touch action highlighted, so as to notify the user that the highlighted Web element is the Web element actually selected by the first action and other enlargement-displayed Web elements are those ones nearby. If the user finds that the highlighted Web element is not the element he wants to select, the user can change his touch position to reselect a Web element to change the highlighted Web element.

Embodiments of the present invention have no limitation on the number of Web elements which are displayed with enlargement each time. When only one Web element is displayed with enlargement each time, the Web element is the element actually pointed by the first action according to the determination of the user terminal based on the first action. When more than one Web element is displayed with enlargement each time, the user terminal may highlight the Web element actually pointed by the first action according to the determination based on the first action. It may be easy for those skilled in the art to conceive of other ways to distinguish the Web element actually pointed by the first action and other Web elements that are also displayed with enlargement, for example, through different fonts, different enlargement scales, different colors, different static and dynamic states, etc.

According to the above method, by displaying the Web element pointed by the first action of the user with enlargement, the user can preview the Web element that he actually selects, so as to determine whether the Web element pointed by the first action is the Web element he desires to click, such that undesired selection caused by for example small-sized touch screen display areas and large-sized contact area of user's finger with the touch screen can be avoided. With enlargement display to help the user preview the Web element actually pointed by the first action, the user can perform subsequent operation only after he clearly views the element to be clicked, so that precise click can be realized. Owning to the realization of precise click, resource wastes caused by the user terminal wrongly triggering the Web element the user does not want to click can be prevented, and Web interaction efficiency can be improved.

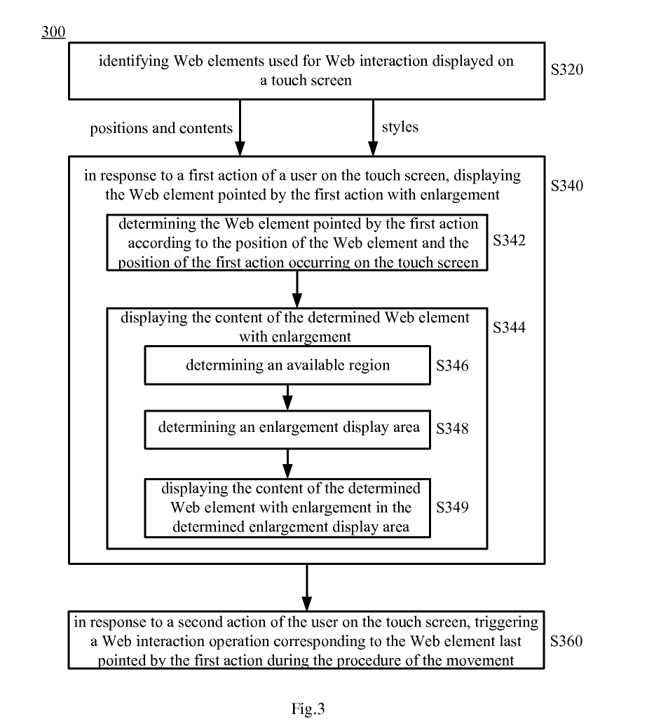

Next, in connection with FIG. 3, a flowchart of a method 300 for touch screen display process according to an embodiment of the present invention will be described in more detail.

At block S320, when an interaction-enabled page (hereinafter, described as a webpage as an example) is displayed on the touch screen, the user terminal identifies Web elements used for Web interaction displayed on the touch screen. According to an embodiment of the present invention, positions and contents of the Web elements can be identified. According to another embodiment of the present invention, in addition to the positions and contents of the Web elements, styles of the Web elements also can be identified.

Herein, the position of a Web element may be represented as the coordinates of the Web element with respect to the up-left corner of the webpage displayed on the touch screen. For example, assuming the coordinates of the up-left corner is (0, 0), the positive direction of the x axis is the horizontally rightward direction on the touch screen, and the positive direction of the y axis is the vertically downward direction on the touch screen, the coordinates of each point in the displayed webpage can be determined accordingly. Also, the position of a Web element may be represented as the coordinates of the Web element with respect to the coordinates of a certain point (e.g., the center of the screen) acting as the origin of the displayed webpage. Once the origin of the screen and the positive directions of the coordinates axes are determined, the coordinates of any position in the displayed webpage can be determined. Certainly, those skilled in the art may conceive of other manners to represent the position of a Web element.

The content of a Web element refers to the content the Web element in the webpage displayed on the touch screen provides to a user, for example, a character string, text, button, digit, etc. The style of a Web element refers to the specific presentation form of the Web element in the displayed webpage, for example, the font, color, background, etc. The user terminal can determine the style and content of a Web element by parsing the webpage displayed on the touch screen. For example, information related to the webpage can be determined by performing information extraction on the programming language of the webpage. The style of a Web element can be determined by extracting a CSS (Cascading Style Sheet) segment, and the content of a Web element can be determined by extracting a content segment. In addition, by parsing the programming language of the webpage, the Web interaction operation corresponding to the Web element can also be determined.

After the content, style, and Web interaction operation of a Web element have been determined by webpage parsing, the position of the Web element in the displayed webpage identified by the user terminal (e.g., the processor of the user terminal) can be recorded in this element's item specific profile in correspondence with its content, style and Web interaction operation, and the item specific profile can be stored in a database.

At block S340, in response to the first action of the user on the touch screen, the Web element pointed by the first action is displayed with enlargement. According to an embodiment of the present invention, the operation may comprise in response to a movement of the occurrence position of the first action on the touch screen, Web elements sequentially pointed by the first action are sequentially displayed with enlargement.

Specifically, when the Web element pointed by the first action of the user is not the Web element the user wants to select, the user can change the position where the first action occurs on the touch screen to select a Web element again. In such a case, the user terminal may, in response to the user moving the position where the first action occurs on the touch screen, display each Web element sequentially pointed by the first action during the movement with enlargement. During the period that the user moves the position of the first action occurring on the touch screen, the user terminal continuously detects the occurrence position of the first action. When a Web element pointed by the first action is determined, the Web element is displayed with enlargement. As such, during the movement of the first action, each Web element sequentially pointed by the first action is sequentially displayed with enlargement in chronological order, enabling the user to preview the Web element pointed by the first action each time during the movement of the first action, and thus to determine the Web element he wants to select.

When the Web element pointed by the first action is displayed with enlargement, operations in blocks S342 and S344 can be executed. No matter in a state that the first action is moved with respect to the touch screen or in a state that the first action stays still with respect to the touch screen, the Web element pointed by the first action refers to the Web element currently pointed by the first action at a certain timing.

At block S342, when the user performs the first action on the touch screen, the user terminal determines the Web element pointed by the first action according to the position of the Web element identified at block S320 and the position of the first action occurring on the touch screen. Particularly, in the case of the first action moving on the touch screen, at block S342, it is required to determine the Web elements sequentially pointed by the first action according to the positions of the Web elements identified at S320 and the positions of the first action occurring on the touch screen during the movement.

For example, a Web element with a distance between the coordinates corresponding to the position of the Web element and the coordinates corresponding to the position of the first action occurring on the touch screen satisfying a predetermined distance condition can be determined as the Web element pointed by the first action. According to an embodiment of the present invention, the predetermined distance condition may include that the distance between the coordinates corresponding to the position of the Web element and the coordinates corresponding to the position of the first action occurring on the touch screen is shortest.

Specifically, the user terminal can use existing techniques to determine the position of the first action occurring on the touch screen (for example, the center of the area of the first action contacting with the touch screen), and thus determine the coordinates of this position in the webpage displayed on the touch screen. By means of the coordinates corresponding to the position of the Web element in the displayed webpage identified by the user terminal at block S320, the user terminal can calculate distances between the coordinates of the occurrence position of the first action and the coordinates each corresponding to each Web element displayed, and determine the Web element corresponding to the minimum value among the calculated distances as the Web element pointed by the first action.

As described above, there may be more than one Web element, including the Web element pointed by the first action as determined by the user terminal, displayed with enlargement. The number of Web elements which need to be displayed with enlargement may be set as demanded. When multiple Web elements are displayed with enlargement each time, in addition to the Web element pointed by the first action as determined by the user terminal, other enlargement-displayed Web elements may be the predetermined number (for example, 1, 2, 3, etc.) or all of Web elements that have distances from the occurrence position of the first action smaller than a predetermined threshold (e.g., 5, 15, 20 mm, etc.), or may be the predetermined number (for example, 1, 2, 3, etc.) of Web elements whose distances among the calculated distances except the minimum one are smaller than those of other Web elements.

At block S344, the user terminal displays the content of the determined Web element with enlargement. Particularly, in the case of the first action moving on the touch screen, at block S344, the user terminal needs to sequentially display the determined Web elements with enlargement.

According to an embodiment of the present invention, if the style of the Web element is identified at block S320, at block S344, the content of the Web element is displayed with enlargement based on the determined style of the Web element. That is to say, the Web element is displayed with enlargement as a whole together with its style according to its presentation form in the webpage, rather than only displaying the content of the Web element with enlargement.

Further, according to an embodiment of the present invention, a region available for displaying a Web element with enlargement can be found in the following manner.

At block S346, according to the position of the first action occurring on the touch screen, a region available for displaying the content of the determined Web element can be determined in the interface displayed on the touch screen. For example, any region except for those overlapped with the occurrence position of the first action can be used as the available region. Further, the available region can be limited in the upper half, lower half, left half or right half of the touch screen. For example, if the first action occurs in the left half of the touch screen, the available region can be limited to the right half of the touch screen.

At block S348, an area close to the position of the first action occurring on the touch screen within the available region can be determined as an enlargement display area. The term “close” as used herein means that the distance between a boundary of the enlargement display area closest to the occurrence position of the first action and the center of the occurrence position is within a predetermined range (such as within 10 mm).

According to an embodiment of the present invention, the enlargement display area may have a fixed shape and size. For example, the enlargement display area may be a rectangle with a length of 4 cm and a width of 3 cm, or a circle with a radius of 2 cm, or other shapes that can be conceived of by those skilled in the art.

At block S349, the content of the determined Web element can be displayed with enlargement in the determined enlargement display area. As such, enlargement display can be performed near the occurrence position of the first action, and even can be performed in a predetermined shape, so as to facilitate user preview. When the content needed to be displayed with enlargement cannot be displayed completely in the enlargement display area, only a portion of the entire content can be displayed, for example, the beginning portion and/or ending portion, or the middle portion while the potions at both ends are omitted. By providing only a part of information, it can also facilitate user preview to determine whether the selected Web element is correct.

At block S360, when the user has found the desired Web element through continuous preview during the movement of the first action for example, the user can perform the second action. In response to the second action by the user on the touch screen, the user terminal triggers a Web interaction operation corresponding to the Web element last pointed by the first action during its movement. For example, when the first action is a touch action and the second action is a touch-stop action, the Web element corresponding to the position at which the user's finger separates from the touch screen is the Web element last pointed by the first action. When the user terminal detects the occurrence of the second action, it triggers the Web element last pointed by the first action as determined by the user terminal, and thus initiating a Web interaction operation and realizing preview-based precise click for the user.

According to an embodiment of the present invention, because the above methods need the user terminal to identify user behaviors and accordingly determine matched operations, two databases can be provided in the user terminal. The first database is used to store item specific profiles of Web elements, and the second database is used to store predefined action rules, such as which action belongs to the first action and which action belongs to the second action. When a webpage is displayed on the touch screen, the user terminal can identify the contents, styles and corresponding Web interaction operations of Web elements through parsing the webpage, and can identify the positions of those Web elements in the presently displayed webpage according to existing techniques. The user terminal can store the content, style, Web interaction operation, and position of a same Web element in correspondence to each other in the first database, as an item specific profile of the Web element. When the user performs an action such as a touch on the touch screen, the user terminal can perform action detection (or behavior detection) to determine the nature of the action and the like, and interpret the action according to the action rules stored in the second database, to determine whether the current action belongs to the first action or the second action. If the current action belongs to the first action, the item specific profile of the Web element pointed by the action is retrieved from the first database, and then the content of the Web element is displayed with enlargement according to the style of the Web element. If the current action belongs to the first action and is continuously moving, according to each of the Web elements sequentially pointed by the first action during its movement, the item specific profile of the Web element pointed by the first action at that time is retrieved from the first database, and the content of this Web element recorded in its item specific profile is displayed with enlargement. If the current action belongs to the second action, the item specific profile of the Web element that is finally pointed by the first action before the second action occurs is retrieved from the first database, and the Web interaction operation of this Web element recorded in its item specific profile is triggered.

In addition, according to an embodiment of the present invention, when a Web element is displayed with enlargement, it may need to not only display the content of the Web element with enlargement according to its style, but also determine an enlargement display area used to present the content of the Web element. These two operations can be performed concurrently after the occurrence of the first action, to present preview information to user more rapidly. For example, after item specific profiles of Web elements are stored in the first database, when the user terminal detects an area contacted by a user's finger, the Web element needed to be previewed by the user can be determined, and at the same time, an available region can be determined according to the area contacted by the user's finger, and thus an enlargement display area can be determined. As such, the content of the Web element can be present to the user according to its style in the enlargement display area.

According to the above method for touch screen display process, when the user finds through preview that the Web element pointed by the first action is not the Web element desired to be selected, by moving the position of the first action occurring on the touch screen, the user can continuously preview different Web elements pointed by the first action, which facilitates the user to find the desired Web element as fast as possible, and thus precise click can be realized. When a Web element is displayed with enlargement according to its style, because the background and other related contents of the Web element are enlarged as a whole, what the user previews is just the same as that originally displayed in the webpage, so that it does not tend to cause confusion and produce unfamiliar contents for the user, user experience can be improved, and judgment can be made faster based on preview.

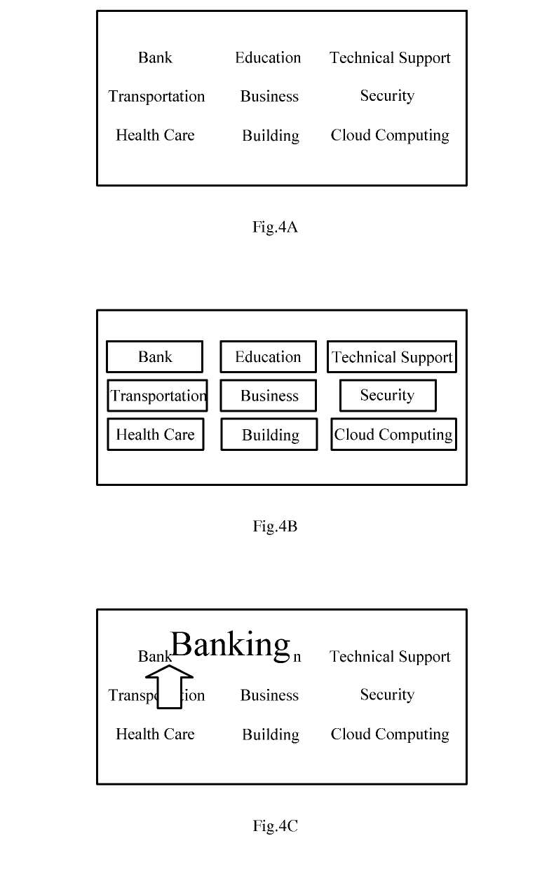

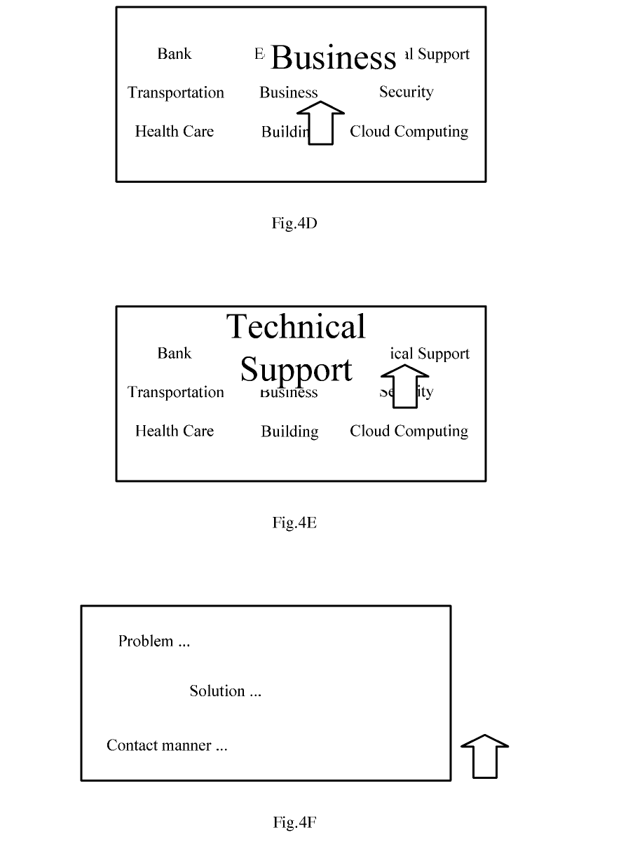

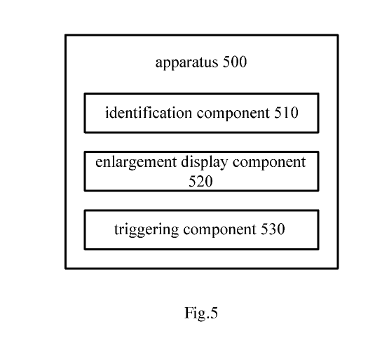

Next, an example of performing precise click on a webpage displayed on a touch screen by using the method provided in the embodiments of the present invention will be described in connection with FIGS. 4A to 4F. FIGS. 4A to 4F schematically shows a simplified webpage displayed on a touch screen and enlargement displayed contents on the touch screen. FIGS. 4A to 4F are merely an example, and do not limit the scope of the present invention. In FIGS. 4C to 4F, the position touched by the user's finger on the touch screen is represented by an arrow.

FIG. 4A shows the form of an original webpage displayed on the touch screen. The webpage comprises links shown as “bank”, “education”, “technical support”, “transportation”, “business”, “security”, “health care”, “building”, and “cloud computing”. Through these links, a new webpage may be opened, authentication information may be required to be input, etc.

In FIG. 4B, the user terminal provided with the touch screen identifies various links in the webpage. In order to help understanding, the identified links are shown with rectangles in FIG. 4B, which may be not visible to users in practice however.

In FIG. 4C, the user touches on the touch screen, and the user terminal determines that the link “bank” is the closest one to the position touched by the user based on distance calculation. Then, the link “bank” is displayed with enlargement for user preview. Herein, take the case that only the Web element pointed by the action is displayed with enlargement as an example. However, as described above, multiple Web elements can be displayed with enlargement together, while only the Web element pointed by the action is highlighted. For example, the links “bank” and “traffic” are displayed with enlargement together, while only the link “bank” is highlighted to notify the user that it is the link actually selected by the user at that time.

In FIG. 4D, the user finds that the link “bank” is not the link he wants to click, and thus the user moves his finger to point to the nearby area. At that point, the user terminal detects that the link “business” is the link closest to the current contact position, and thus the link “business” is displayed with enlargement for user preview.

In FIG. 4E, the user finds that the link “business” is still not the link he wants to click, and thus the user continues to move his finger. At that point, the user terminal detects that the link “technique support” is the link closest to the current contact position, and thus the link “technique support” is displayed with enlargement for user preview.

In FIG. 4F, the user finds that the link “technique support” is the link he wants to click, and thus the user separates his finger from the touch screen. The user terminal detects that the touch is over, and then a Web interaction related to the link “technique support” is triggered, causing a new webpage, which is displayed on the touch screen, to be popped out as the link “technique support” is clicked.

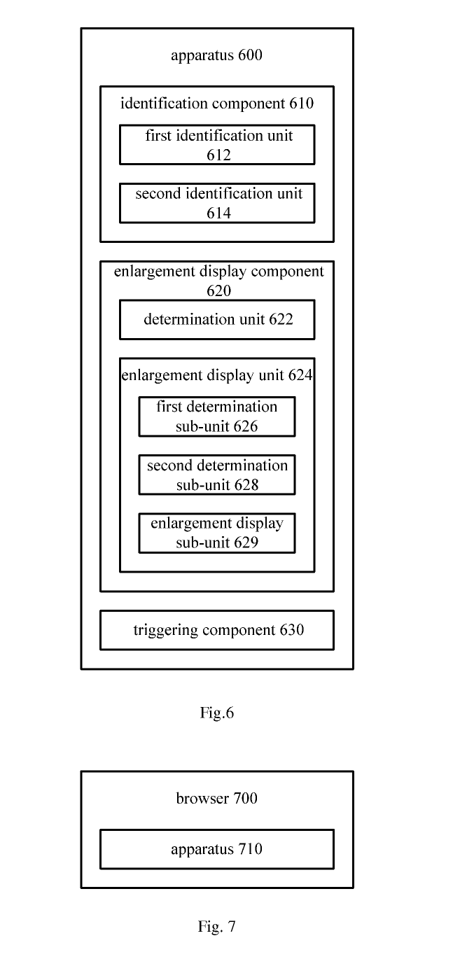

The methods for touch screen display process according to embodiments of the present invention have been described above in connection with FIGS. 2, 3 and 4A to 4F. Next, a structural block diagram of an apparatus for touch screen display process according to an embodiment of the present invention will be described with reference to FIGS. 5 and 6, and a structural block diagram of a browser according to an embodiment of the present invention will be described with reference to FIG. 7.

In FIG. 5, an apparatus 500 comprises an identification component 510, an enlargement display component 520, and a triggering component 530. The identification component 510 may be configured to identify Web elements used for Web interaction displayed on a touch screen. The enlargement display component 520 may be configured to display the Web element pointed by the first action with enlargement in response to a first action of a user on the touch screen. The triggering component 530 may be configured to trigger a Web interaction operation corresponding to the Web element pointed by the first action in response to a second action of the user on the touch screen.

The identification component 510, the enlargement display component 520 and the triggering component 530 can be realized by a processor. A reference to the corresponding description about the method 200 can be made for the above-mentioned and other operations and/or functions of the identification component 510, the enlargement display component 520 and the triggering component 530, which will not be described in detail herein to avoid repetition.

In the apparatus for touch screen display process according to an embodiment of the present invention, by displaying the Web element pointed by the first action of the user with enlargement, the user can preview the Web element that he actually selects, so as to determine whether the Web element pointed by the first action is the Web element he desires to click, such that undesired selection caused by for example small-sized touch screen display areas and large-sized contact area of user's finger with the touch screen can be avoided. With enlargement display to help the user preview the Web element actually pointed by the first action, the user can perform subsequent operation only after he clearly views the element to be clicked, so that precise click can be realized. Owning to the realization of precise click, resource wastes caused by the user terminal wrongly triggering the Web element the user does not want to click can be prevented, and Web interaction efficiency can be improved.

In FIG. 6, an identification component 610, an enlargement display component 620 and a triggering component 630 included in an apparatus 600 are substantially the same as the identification component 510, the enlargement display component 520 and the triggering component 530 included in the apparatus 500.

According to an embodiment of the present invention, the enlargement display component 620 may be further configured to sequentially display the Web elements pointed by the first action with enlargement in response to the user moving the position of the first action occurring on the touch screen. In such a case, the triggering component 630 may be further configured to trigger the Web interaction operation corresponding to the Web element last pointed by the first action during the procedure of the movement, in response to the second action of the user on the touch screen.

According to an embodiment of the present invention, the identification component 610 may also comprise a first identification unit 612. The first identification unit 612 may be configured to identify positions and contents of the Web elements used for Web interaction displayed on the touch screen. In the case that the positions and contents of the Web elements are identified, the enlargement display component 620 may comprise a determination unit 622 and an enlargement display unit 624. The determination unit 622 may be configured to determine the Web element pointed by the first action according to the position of the Web element and the position of the first action occurring on the touch screen. The enlargement display unit 624 may be configured to display the content of the determined Web element with enlargement. Particularly, in the case of the first action moving on the touch screen, the determination unit 622 may be configured to sequentially determine the Web elements pointed by the first action according to the positions of the Web elements and the positions of the first action occurring on the touch screen. The magnification and display unit 624 may be configured to sequentially display the contents of the determined Web elements with enlargement.

According to an embodiment of the present invention, the determination unit 622 may be specifically configured to determine the Web element with a distance between the coordinates corresponding to the position of the first action occurring on the touch screen and the coordinates corresponding to the position of the Web element satisfying a predetermined distance condition as the Web element pointed by the first action.

According to an embodiment of the present invention, the predetermined distance condition may comprise that the distance between the coordinates corresponding to the position of the first action occurring on the touch screen and the coordinates corresponding to the position of the Web element is shortest.

According to an embodiment of the present invention, the identification component 610 may further comprise a second identification unit 614. The second identification unit 614 may be configured to identify styles of the Web elements used for Web interaction displayed on the touch screen. In the case that the styles of the Web elements are identified, the enlargement display unit 624 may be specifically configured to display the content of the determined Web element with enlargement according to the style of the determined Web element.

According to an embodiment of the present invention, the enlargement display unit 624 may comprise a first determination sub-unit 626, a second determination sub-unit 628, and an enlargement display sub-unit 629. The first determination sub-unit 626 may be configured to determine an available region for displaying the content of the determined Web element in an interface displayed on the touch screen, according to the position of the first action occurring on the touch screen. The second determination sub-unit 628 may be configured to determine an area close to the position of the first action occurring on the touch screen within the available region as an enlargement display area. The magnification and display sub-unit 629 may be configured to display the content of the determined Web element with enlargement in the determined enlargement display area. For example, the enlargement display area determined by the second determination sub-unit 628 may have a fixed shape and size.

According to an embodiment of the present invention, the first action may be a touch action, and in this case, the second action may be a touch-stop action. Alternatively, the first action may be an action satisfying a first predetermined condition, and the second action may be an action satisfying a second predetermined condition. For example, the first predetermined condition may be related to at least one of a time domain behavior and a spatial domain behavior of the first action, and the second predetermined condition may be related to at least one of a time domain behavior and a spatial domain behavior of the second action.

Embodiments described above may be implemented separately or in combined manners. the first identification unit 612, the second identification unit 614, the determination unit 622, the enlargement display unit 624, the first determination sub-unit 626, the second determination sub-unit 628, and the enlargement display sub-unit 629 included in the apparatus 600 may be realized by one or more processor. A reference to the corresponding description about the method 300 can be made for the above-mentioned and other operations and/or functions of these components as well as the identification component 610, the enlargement display component 620 and the triggering component 630, which will not be described in detail herein to avoid repetition.

According to the apparatus for touch screen display process described above, when the user finds through preview that the Web element pointed by the first action is not the Web element desired to be selected, by moving the position of the first action occurring on the touch screen, the user can continuously preview different Web elements pointed by the first action, which facilitates the user to find the desired Web element as fast as possible, and thus precise click can be realized. When a Web element is displayed with enlargement according to its style, because the background and other related contents of the Web element are enlarged as a whole, what the user previews is just the same as that originally displayed in the webpage, so that it does not tend to cause confusion and produce unfamiliar contents for the user, user experience can be improved, and judgment can be made faster based on preview.

According to an embodiment of the present invention, the apparatuses shown in FIG. 5 and FIG. 6 can be not only installed or integrated into a user terminal with a touch screen as a separate software packet, but also embedded into a browser 700 shown in FIG. 7 as a processing component. The apparatus 710 included in the browser 700 may be the apparatus 500 of FIG. 5 or the apparatus 600 of FIG. 6. When the browser is used to browse a webpage, preview-based link selection can be achieved to realize precise click due to the presence of the apparatus according to embodiments of the present invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for touch screen display process, comprising:
identifying, with a processing device, Web elements used for Web interaction displayed on a touch screen;
in response to a first action of a user on the touch screen, displaying the Web element pointed by the first action with enlargement; and
in response to a second action of the user on the touch screen, triggering a Web interaction operation corresponding to the Web element pointed by the first action.

2. The method according to claim 1, wherein in response to a first action of a user on the touch screen, displaying the Web element pointed by the first action with enlargement comprises:
in response to the user moving the position of the first action occurring on the touch screen, sequentially displaying the Web elements pointed by the first action with enlargement; and
in response to a second action of the user on the touch screen, triggering a Web interaction operation corresponding to the Web element pointed by the first action comprises: triggering a Web interaction operation corresponding to the Web element last pointed by the first action during the procedure of the movement.

3. The method according to claim 2, wherein identifying Web elements used for Web interaction displayed on a touch screen comprises:
identifying positions and contents of the Web elements used for Web interaction displayed on the touch screen;
wherein, sequentially displaying the Web elements pointed by the first action with enlargement comprises:
sequentially determining the Web elements pointed by the first action according to the positions of the Web elements and the positions of the first action occurring on the touch screen; and
sequentially displaying the contents of the determined Web elements with enlargement.

4. The method according to claim 1, wherein identifying Web elements used for Web interaction displayed on a touch screen comprises:
identifying positions and contents of the Web elements used for Web interaction displayed on the touch screen;
wherein, displaying the Web element pointed by the first action with enlargement comprises:
determining the Web element pointed by the first action according to the position of the Web element and the position of the first action occurring on the touch screen; and
displaying the content of the determined Web element with enlargement.

5. The method according to claim 3, wherein determining the Web element pointed by the first action according to the position of the Web element and the position of the first action occurring on the touch screen comprises:
determining the Web element with a distance between the coordinates corresponding to the position of the first action occurring on the touch screen and the coordinates corresponding to the position of the Web element satisfying a predetermined distance condition as the Web element pointed by the first action.

6. The method according to claim 5, wherein the predetermined distance condition comprises that the distance between the coordinates corresponding to the position of the first action occurring on the touch screen and the coordinates corresponding to the position of the Web element is shortest.

7. The method according to claim 3, wherein identifying Web elements used for Web interaction displayed on a touch screen further comprises:
identifying styles of the Web elements used for Web interaction displayed on the touch screen;
wherein said displaying the content of the determined Web element with enlargement comprises:
displaying the content of the determined Web element with enlargement according to the style of the determined Web element.

8. The method according to claim 3, wherein displaying the content of the determined Web element with enlargement comprises:
according to the position of the first action occurring on the touch screen, determining an available region for displaying the content of the determined Web element in an interface displayed on the touch screen;
determining an area close to the position of the first action occurring on the touch screen within the available region as an enlargement display area; and
displaying the content of the determined Web element with enlargement in the determined enlargement display area.

9. The method according to claim 1, wherein:
the first action is a touch action, and the second action is a touch-stop action; or
the first action is an action satisfying a first predetermined condition, and the second action is an action satisfying a second predetermined condition.

10. The method according to claim 9, wherein the first predetermined condition is related to at least one of a time domain behavior and a spatial domain behavior of the first action, and the second predetermined condition is related to at least one of a time domain behavior and a spatial domain behavior of the second action.

11. An apparatus for touch screen display process, comprising:
an identification component, configured to identify Web elements used for Web interaction displayed on a touch screen;
an enlargement display component, configured to in response to a first action of a user on the touch screen, display the Web element pointed by the first action with enlargement; and
a triggering component, configured to in response to a second action of the user on the touch screen, trigger a Web interaction operation corresponding to the Web element pointed by the first action.

12. The apparatus according to claim 11, wherein the enlargement display component is further configured to, in response to the user moving the position of the first action occurring on the touch screen, sequentially display the Web elements pointed by the first action with enlargement; and
the triggering component is further configured to, in response to the second action of the user on the touch screen, trigger the Web interaction operation corresponding to the Web element last pointed by the first action during the procedure of the movement.

13. The apparatus according to claim 12, wherein the identification component comprises a first identification unit, configured to identify positions and contents of the Web elements used for Web interaction displayed on the touch screen, and wherein, the enlargement display component comprises:
a determination unit, configured to sequentially determine the Web elements pointed by the first action according to the positions of the Web elements and the positions of the first action occurring on the touch screen; and
an enlargement display unit, configured to sequentially display the contents of the determined Web elements with enlargement.

14. The apparatus according to claim 11, wherein the identification component comprises a first identification unit, configured to identify positions and contents of the Web elements used for Web interaction displayed on the touch screen, wherein the enlargement display component comprises:
a determination unit, configured to determine the Web element pointed by the first action according to the position of the Web element and the position of the first action occurring on the touch screen; and
an enlargement display unit, configured to display the content of the determined Web element with enlargement.

15. The apparatus according to claim 13, wherein the determination unit is configured to determine the Web element with a distance between the coordinates corresponding to the position of the first action occurring on the touch screen and the coordinates corresponding to the position of the Web element satisfying a predetermined distance condition as the Web element pointed by the first action.

16. The apparatus according to claim 15, wherein the predetermined distance condition comprises that the distance between the coordinates corresponding to the position of the first action occurring on the touch screen and the coordinates corresponding to the position of the Web element is shortest.

17. The apparatus according to claim 13, wherein the identification component further comprises a second identification unit, configured to identify styles of the Web elements used for Web interaction displayed on the touch screen, wherein the enlargement display unit is configured to display the content of the determined Web element with enlargement according to the style of the determined Web element.

18. The apparatus according to claim 13, wherein the enlargement display unit comprises:
a first determination sub-unit, configured to according to the position of the first action occurring on the touch screen, determine an available region for displaying the content of the determined Web element in an interface displayed on the touch screen;
a second determination sub-unit, configured to determine an area close to the position of the first action occurring on the touch screen within the available region as an enlargement display area; and
an enlargement display sub-unit, configured to display the content of the determined Web element with enlargement in the determined enlargement display area.

19. The apparatus according to claim 11, wherein:
the first action is a touch action, and the second action is a touch-stop action; or
the first action is an action satisfying a first predetermined condition, and the second action is an action satisfying a second predetermined condition.

20. The apparatus according to claim 19, wherein the first predetermined condition is related to at least one of a time domain behavior and a spatial domain behavior of the first action, and the second predetermined condition is related to at least one of a time domain behavior and a spatial domain behavior of the second action.
